(19) United States
(12) Patent Application Publication
(10) Pub. No.: US 2010/0255893 A1
(43) Pub. Date: Oct. 7, 2010

(54) MOBILE COMMUNICATION APPARATUS AND ANTENNA STRUCTURE

(75) Inventors: Akio Ihara, Tokyo (JP); Minoru Sakurai, Kanagawa-ken (JP); Makoto Tabata, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/693,616

(22) Filed: Jan. 26, 2010

(30) Foreign Application Priority Data
Apr. 7, 2009 (JP) P2009-93330

(51) Int. Cl. H04W 88/02; H01Q 1/24

(52) U.S. Cl. 455/575.7; 343/702

(57) ABSTRACT

A mobile communication apparatus configured to be provided with an extra antenna has a printed board provided with an antenna feed point, an antenna having a spring-like contact and provided on the printed board, and a housing constituted by a first case and a second case fixed into each other. The printed board and the antenna are arranged between and pressed by the first case and the second case. The antenna feed point and the spring-like contact are in contact with and electrically connected to each other by means of elastic force of the spring-like contact caused upon the first case and the second case being fixed into each other. The housing has a space for containing the extra antenna such that the extra antenna is electrically connected to the antenna feed point by means of the elastic force.

### CROSS REFERENCE TO RELATED APPLICATIONS

This application is based upon and claims the benefit of priority from the prior Japanese Patent Application No. 2009-93330 filed on Apr. 07, 2009; the entire contents of which are incorporated herein by reference.

### BACKGROUND OF THE INVENTION

1. FIELD OF THE INVENTION

The present invention relates to a mobile communication apparatus and an antenna structure, and in particular to a mobile communication apparatus configured to have two separate antennas.

2. DESCRIPTION OF THE RELATED ART

Mobile communication apparatuses (mobile phones, etc.) are required to be adapted for multiple radio frequency bands, such as 800, 1500 and 2000 MHz bands. Some communication service providers need not the 800 MHz band. In some cases, exact frequencies in the respective frequency bands are slightly different from one another.

A manufacturer of a mobile communication apparatus may consider, for a common design of the antennas, providing the apparatus with two separate antennas configured such that a first one of the two antennas is adapted for the 1500 and 2000 MHz bands and that a second one of the two antennas is adapted for the 800 MHz band positioned far apart from the other bands. Then, it is preferable to provide the mobile communication apparatus with a basic structure adapted for mounting both the first and second antennas thereon. Assuming that the second antenna is removed in accordance with a provider's specification that need not the second antenna, the apparatus should preferably be configured such that portions other than the second antenna are connected to one another without any change of design.

Further, the mobile communication apparatus should preferably agree with the provider's specification that requires slightly different frequencies in the respective frequency bands by slightly modifying the first or second antenna without modifying the main body of the apparatus. Further, the mobile communication apparatus should preferably agree with a structural specification of the main body that is more or less different depending on the provider by more or less modifying the first or second antenna in accordance with the difference.

Thus, the mobile communication apparatus should preferably be provided with a basic structure adapted for mounting both the first and second antennas, and needs no change of design even for a specification that need not the second antenna.

A mobile communication apparatus having an antenna adapted for multiple frequency bands is known, although not having an object of a common design, as disclosed in Japanese Patent Publication of Unexamined Applications (Kokai), No. 2008-72204. The mobile communication apparatus of JP 2008-72204 has an antenna 7 constituted by a first radiation element 8 (or 18) of an 800 MHz band (830-885 MHz) and a second radiation element 9 (or 13) of a 2 GHz band (1920-2170 MHz).

FIGS. 1-14 of JP 2008-72204 disclose various embodiments of structures of the first and second radiation elements. According to a basic structure of those embodiments, a matching circuit 11 mounted on a circuit board 5 is connected to the second radiation element 9 (or 13) of the 2 GHz band through a feed element 15, and the first radiation element 8 (or 18) of the 800 MHz band is connected to a side of a feed point of the second radiation element 9 (or 13).

JP 2008-72204 does not disclose that the mobile communication apparatus is configured such that the second radiation element 9 (or 13) of the 2 GHz band and the first radiation element 8 (or 18) of the 800 MHz band are separate and can be removed. That may cause a problem that the design of the whole antenna 7 needs to be changed in order to remove, e.g., the first radiation element 8 (or 18) of the 800 MHz band.

### SUMMARY OF THE INVENTION

Accordingly, an object of the present invention is to provide a mobile communication apparatus having a first antenna and a second antenna being separate from each other, and having a structure adapted for steadily connecting the both antennas to a feed point after the antennas are mounted, and for steadily connecting the first antenna to the feed point after the second antenna is removed and only the first antenna remains. Another object is to prevent interference and to increase a degree of freedom of parts arrangement by having the separate antennas.

To achieve the above object, according to one aspect of the present invention, a mobile communication apparatus configured to be provided with an extra antenna has a printed board provided with an antenna feed point, an antenna having a spring-like contact and provided on the printed board, and a housing constituted by a first case and a second case fixed into each other. The printed board and the antenna are arranged between and pressed by the first case and the second case. The antenna feed point and the spring-like contact are in contact with and electrically connected to each other by means of elastic force of the spring-like contact caused upon the first case and the second case being fixed into each other. The housing has a space for containing the extra antenna such that the extra antenna is electrically connected to the antenna feed point by means of the elastic force.

### BRIEF DESCRIPTION OF THE DRAWINGS

FIG. 1 is a disassembled perspective view of a mobile communication apparatus 100 of an embodiment of the present invention.

FIG. 2 is a disassembled perspective view illustrating an antenna mounted on a second case 20 of the mobile communication apparatus 100 of the embodiment of the present invention.

FIGS. 3A and 3B show a main face of a first case 1 of the mobile communication apparatus 100 of the embodiment of the present invention.

FIGS. 4A and 4B show a cross section of the mobile communication apparatus 100 of the embodiment of the present invention along a side face.

### DETAILED DESCRIPTION OF THE INVENTION

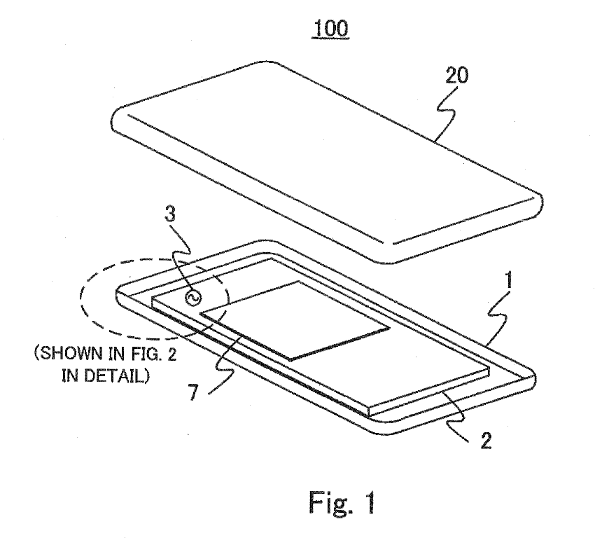

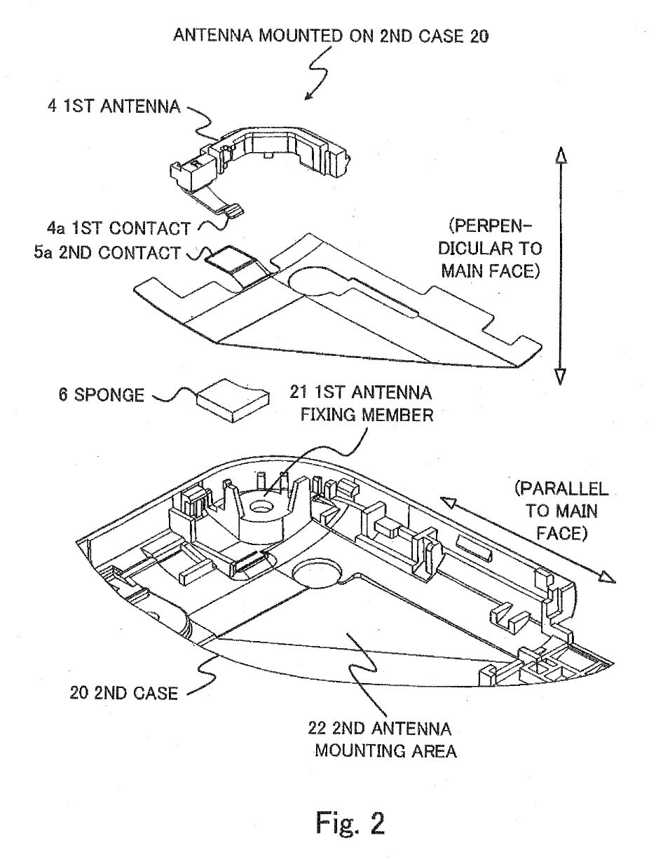

FIG. 1 is a disassembled perspective view of a mobile communication apparatus 100 of an embodiment of the present invention. FIG. 2 is a disassembled perspective view illustrating an antenna mounted on a second case 20 of the mobile communication apparatus 100 of the embodiment of the present invention. FIGS. 1 and 2 are drawn upside down with respect to each other. The embodiment will be explained below with reference to FIGS. 1 and 2.

As shown in FIG. 1, the mobile communication apparatus 100 is an example of a mobile phone of a single body. The mobile communication apparatus 100 is formed in a finished state by a first case 1 and a second case 20 fixed into each other. A display unit, operation keys and so on that are not shown are mounted on a back of the first case 1 that is not shown. Main portions mounted on the first case 1 are a printed board 2, a feed point 3 provided on the printed board 2, and a shield plate 7 mounted on the printed board 2.

As shown in FIG. 2, main portions mounted on the second case 20 are a first antenna 4, a first contact 4a included in the first antenna 4, a second antenna 5, a second contact 5a included in the second antenna 5, a sponge 6 and so on. The second case 20 includes a first antenna fixing member 21 for fixing the first antenna 4, a second antenna mounting area 22 for mounting the second antenna 5.

The first antenna 4 is formed by a metal plate and so on, and includes line lengths for 1500 and 2000 MHz bands. The second antenna 5 is formed by a thin film, has a metallic radiation element 5b printed on the film, and includes a line length for an 800 MHz band. The first antenna 4 is mounted in a direction parallel to a main face of the second case 20 and on a side close to a side face of the second case 20. The second antenna 5 is directed from the side face to the inside of the second case 20.

If the first case 1 and the second case 20 are fixed into each other, the feed point 3 on the printed board 2, the first contact 4a of the first antenna 4, the second contact 5a of the second antenna 5 and the sponge 6 are layered on top of one another under pressure in a direction perpendicular to the main face of the first case 1, and the feed point 3, the first contact 4a and the second contact 5a are electrically connected to one another.

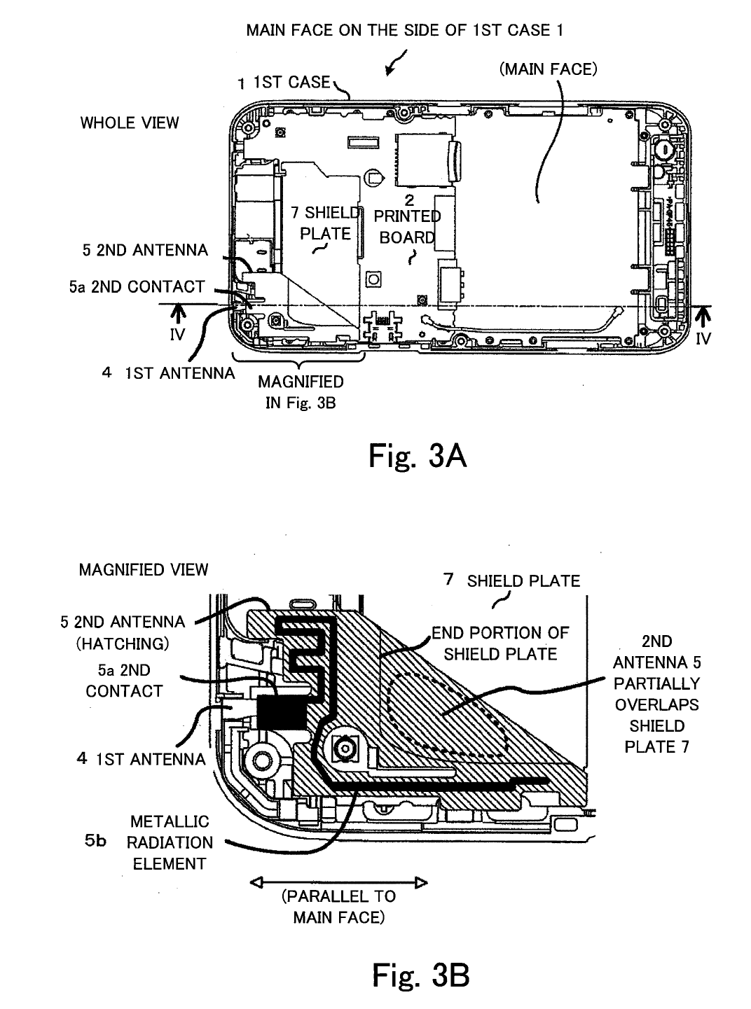

Then, a portion including the second antenna 5 will be explained in detail. FIG. 3A shows a whole main face of the first case 1 of the mobile communication apparatus 100 of the embodiment of the present invention. FIG. 3B shows a magnified view of the antenna portion. The second contact 5a of the second antenna 5, the first contact 4a (not shown) of the first antenna 4 and the feed poin3 (not shown) on the printed board 2 are arranged in top to bottom order, and electrically connected to one another in the direction perpendicular to the main face through the contact caused by the pressure.

The first antenna 4 is adapted for the 1500 MHz band and the 2000 MHz band. As having relatively short line lengths and being shaped to be small, the first antenna 4 is formed by a metal plate and so on, and arranged in a portion close to a side face of a housing constituted by the first case 1 and the second case 20 in a compact manner.

The second antenna 5 (indicated by hatching) is adapted for the 800 MHz band. As having a relatively long line length, the second antenna 5 is formed as a thin film-like antenna and can be arranged in a space inside the housing rather than in the portion close to the side face. Further, as the second antenna 5 is positioned apart from the first antenna 4 (e.g., opposite the first antenna 4 with respect to the feed point 3), interference between both the antennas can be prevented.

The second antenna 5 is formed by a thin film and provided with a wide area from a viewpoint of strength or handling. In that case, a portion of the second antenna 5 may possibly overlap an area of the shield plate 7 on the printed board 2. Even if they overlap each other, the metallic radiation element 5b extended from the second contact 5a of the second antenna 5 is formed by, e.g., being printed on the film in order not to overlap, or in order to keep clear of, the shield plate 7 in the direction perpendicular to the main face (or, perpendicular to the printed board 2), so that degradation of antenna performance can be prevented.

Then, the embodiment will be explained from a viewpoint of a common design. The first antenna 4 is adapted for the 1500 MHz band and the 2000 MHz band which are requisite frequency bands regardless of a provider's specification and requires a relatively small-sized antenna. Further, the portion close to the side face of the housing formed by the first case 1 and the second case 20 of the mobile communication apparatus 100 can be more or less commonly designed regardless of the provider's specification. Thus, the first antenna 4 should be arranged in the portion close to the side face of the first case 1 so that the shape of the first antenna 4 and the structure of the portion close to the side face of the housing can be commonly designed.

The second antenna 5 is adapted for the 800 MHz band that may be unnecessary in some cases depending on the provider's specification. Thus, the second antenna 5 is formed as a thin film-like antenna and can be mounted in a space inside the housing rather than in the portion close to the side face of the housing formed by the first case 1 and the second case 20 without a need of a large housing. The housing design can thereby be made common regardless of whether the second antenna 5 is mounted or not.

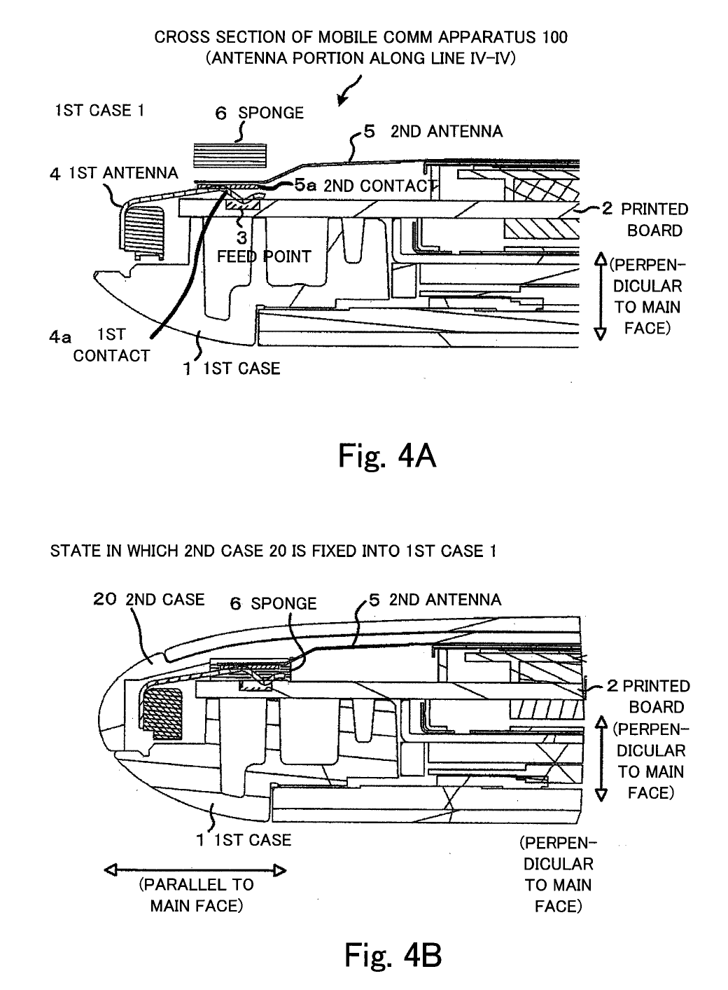

Then, condition of the connection among the feed point 3, the first contact 4a and the second contact 5a will be explained. FIG. 4 shows a cross section along the side face of the mobile communication apparatus 100 of the embodiment of the present invention, illustrating the antenna portion included in the cross section along a line “IV-IV” shown in FIG. 3.

FIG. 4A shows a state in which parts are mounted on the first case 1 being not yet fixed into the second case 20. The first case 1, the feed point 3 on the printed board 2, the first contact 4a of the first antenna 4, the second contact 5a of the second antenna 5 and the sponge 6 are arranged in bottom-to-top order in the direction perpendicular to the main face of the first case 1. The first contact 4a of the first antenna 4 is a spring-like contact.

Although the first antenna 4, the second antenna 5 and the sponge 6 are mounted on and fixed to the second case 20 and then put on the first case 1 as described with reference to FIG. 2, the second case 20 is omitted to be shown in FIG. 4A.

FIG. 4B shows a state in which the second case 20 is put on top of the sponge 6 and pressed, and the first case 1 and the second case 20 are fixed into each other. The sponge 6 is squashed and gets into fringe portions of the first contact 4a and the second contact 5a. The spring-like first contact 4a is pressed and squashed flat in the direction perpendicular to the main face of the first case 1. The first contact 4a thereby produces elastic force so as to make sure of the connection through the contact among the feed point 3, the first contact 4a and the second contact 5a. The squashed sponge 6 produces an effect of protecting the above contacts and an effect of preventing the above contacts from slipping off one another.

The spring-like first contact 4a can be designed to produce sufficient elastic force even if the second antenna 5 is not mounted and the arrangement shown in FIG. 4B lacks the thickness of the second antenna 5. The first contact 4a of the first antenna 4 can thereby make sure of the connection through the contact to the feed point 3.

According to the embodiment of the present invention described above, the mobile communication apparatus having the first antenna and the second antenna being separate from each other can be configured such that both the antennas are mounted and steadily connected to the feed point. Further, even if the second antenna is removed and only the first antenna is mounted in the same configuration, the first antenna can be steadily connected to the feed point.

Although the sponge 6 is arranged between the second antenna 5 and the second case 20, the sponge 6 may be made of conductive material and arranged between the first antenna 4 and the second antenna 5. Further, the sponge 6 may be made of nonconductive material and arranged between the first antenna 4 and the second antenna 5 so that the first antenna 4 and the second antenna 5 are connected through a capacitive coupling.

Moreover, the present invention can be applied to a mobile phone, a PHS and other radio devices. The present invention can be applied to one of two housing sections of a flip type mobile phone.

The particular hardware or software implementation of the present invention may be varied while still remaining within the scope of the present invention. It is therefore to be understood that within the scope of the appended claims and their equivalents, the invention may be practiced otherwise than as specifically described herein.

What is claimed is:

1. A mobile communication apparatus configured to be provided with an extra antenna, comprising:
a printed board provided with an antenna feed point;
an antenna having a spring-like contact, the antenna being provided on the printed board; and
a housing constituted by a first case and a second case fixed into each other, the printed board and the antenna being arranged between and pressed by the first case and the second case, the antenna feed point and the spring-like contact being in contact with and electrically connected to each other by means of elastic force of the spring-like contact caused upon the first case and the second case being fixed into each other, the housing having a space for containing the extra antenna such that the extra antenna is electrically connected to the antenna feed point by means of the elastic force.

2. The mobile communication apparatus according to claim 1, wherein the antenna is formed by a metal plate.

3. The mobile communication apparatus according to claim 1, wherein the extra antenna configured to be provided to the mobile communication apparatus is formed by a thin film to which a metallic radiation element is provided.

4. The mobile communication apparatus according to claim 1, further comprising a sponge arranged between the feed point and the second case.

5. The mobile communication apparatus according to claim 1, wherein the antenna is provided close to a side of the housing, and the space is positioned opposite the antenna with respect to the feed point.

6. The mobile communication apparatus according to claim 1, wherein the extra antenna configured to be provided to the mobile communication apparatus is formed by a thin film to which a metallic radiation element is provided and the printed board is provided with a shield plate, the metallic radiation element being arranged such as to keep clear of the shield plate as viewed from a direction perpendicular to the printed board.

7. A mobile communication apparatus, comprising:
a housing constituted by a first case and a second case fixed into each other;
a printed board provided in the housing, the printed board being provided with an antenna feed point;
a first antenna provided in the housing, the first antenna having a spring-like first contact overlapping and being in contact with the antenna feed point between the first case and the second case in a direction perpendicular to a main, face of the first case, the contact between the first contact and the antenna feed point being enhanced by elastic force caused by the first contact being pressed upon the first case and the second case being fixed into each other.

8. The mobile communication apparatus according to claim 7, further comprising a sponge provided between the first contact and the second case.

9. The mobile communication apparatus according to claim 7, wherein the housing is provided with a space between the first contact and the second case for a second contact of a film-like second antenna, and the first contact can be further pressed by a thickness of the second contact.

10. The mobile communication apparatus according to claim 7, further comprising a film-like second antenna provided in the housing and having a second contact, wherein the first contact and the second contact overlapping and being in contact with the antenna feed point between the first case and the second case in a direction perpendicular to a main face of the first case, the contact between the first contact and the second contact and the antenna feed point being enhanced by elastic force caused by the first contact being pressed upon the first case and the second case being fixed into each other.

11. The mobile communication apparatus according to claim 10, further comprising a sponge provided between the second contact and the second case, or between the first contact and the second contact.

12. The mobile communication apparatus according to claim 10, wherein the first antenna is arranged close to an end portion of the housing in a direction parallel to the main face of the first case, and the second antenna has a metallic radiation element arranged on a side opposite the first antenna with respect to the antenna feed point.

13. The mobile communication apparatus according to claim 10, wherein the printed board has a shield plate, and a film portion of the second antenna without a metallic radiation element overlaps the shield plate as viewed from a direction perpendicular to the main face, and the metallic radiation element in the second antenna keeps clear of the shield plate as viewed from the direction perpendicular to the main face.

14. The mobile communication apparatus according to claim 10, wherein the elastic force enhances contact between the antenna feed point and the first contact even if the second antenna is removed.

15. An antenna structure of a mobile communication apparatus configured to be provided with an extra antenna, comprising:
a printed board provided with an antenna feed point;
an antenna having a spring-like contact, the antenna being provided on the printed board; and
a first case and a second case constituting a housing of the mobile communication apparatus by fixing into each other, the printed board and the antenna being arranged between and pressed by the first case and the second case, the antenna feed point and the spring-like contact being in contact with and electrically connected to each other by means of elastic force of the spring-like contact caused upon the first case and the second case being fixed into each other, the housing having a space for containing the extra antenna such that the extra antenna is electrically connected to the antenna feed point by means of the elastic force.
